(19) United States
(12) Patent Application Publication
(10) Pub. No.: US 2023/0385620 A1
(43) Pub. Date: Nov. 30, 2023

(54) SPIKE NEURAL NETWORK CIRCUIT

(71) Applicant: Electronics and Telecommunications Research Institute, Daejeon (KR)

(72) Inventors: Kwang IL OH, Daejeon (KR); Byung-Do YANG, Daejeon (KR); Dongwon LEE, Daejeon (KR); Jae-Jin LEE, Daejeon (KR)

(73) Assignee: Electronics and Telecommunications Research Institute, Daejeon (KR)

(21) Appl. No.: 18/125,553

(22) Filed: Mar. 23, 2023

(30) Foreign Application Priority Data
May 30, 2022 (KR) 10-2022-0065968

(51) Int. Cl. G06N 3/063; G06N 3/049

(52) U.S. Cl. CPC G06N 3/063; G06N 3/049

(57) ABSTRACT

Disclosed is a spike neural network circuit which includes a pulse generator that receives an input spike signal and generates a first modulation pulse and a second modulation pulse based on the input spike signal, first and second current source arrays controlled based on a weight memory, a membrane capacitor, a first switch that delivers a first calculation signal generated from the first current source array to the membrane capacitor, in response to the first modulation pulse, and a second switch that delivers a second calculation signal generated from the second current source array to the membrane capacitor, in response to the second modulation pulse.

### CROSS-REFERENCE TO RELATED APPLICATIONS

This application claims priority under 35 U.S.C. § 119 to Korean Patent Application No. 10-2022-0065968 filed on May 30, 2022, in the Korean Intellectual Property Office, the disclosures of which are incorporated by reference herein in their entireties.

### BACKGROUND

Embodiments of the present disclosure described herein relate to a circuit for implementing an artificial intelligence network, and more particularly, relate to a spike neural network circuit implemented based on a semiconductor circuit.

A spike neural network (SNN) circuit is one of methods for implementing an artificial intelligence network which performs network calculation for an input and outputs an output. The SNN circuit may deliver a signal in the form of a pulse or spike having a short time width.

Recently, with the high performance and high integration of the SNN circuit, research has been conducted to reduce an area of a synaptic circuit. The synapse circuit may include an array of current sources, each of which is controlled by a binary weight and has a size corresponding to a power of 2. The current sources of the current source array may correspond to bits of the binary weight, respectively. In this case, when high-precision calculation is required in the synapse circuit, transistors included in the current source array become excessively large in size.

### SUMMARY

Embodiments of the present disclosure are to address the above-mentioned technical problems. In detail, embodiments of the present disclosure provide a spike neural network circuit in which an area of a synapse circuit is reduced.

According to an embodiment, a spike neural network circuit may include a pulse generator that receives an input spike signal and generates a first modulation pulse and a second modulation pulse based on the input spike signal, first and second current source arrays controlled based on a weight memory, a membrane capacitor, a first switch that delivers a first calculation signal generated from the first current source array to the membrane capacitor, in response to the first modulation pulse, and a second switch that delivers a second calculation signal generated from the second current source array to the membrane capacitor, in response to the second modulation pulse.

In an embodiment, the first modulation pulse may be activated for a shorter time than the second modulation pulse.

In an embodiment, the first modulation pulse and the second modulation pulse may be activated from the same time point.

In an embodiment, the membrane capacitor may be configured to accumulate the first calculation signal during a time interval when the first modulation pulse is activated and accumulate the second calculation signal during a time interval when the second modulation pulse is activated.

In an embodiment, a first current source for generating a current of a smallest magnitude among current sources of the first current source array may generate a current of the same magnitude as a second current source for generating a current of a smallest magnitude among current sources of the second current source array.

In an embodiment, the first current source and the second current source may include a first transistor and a second transistor, respectively. A channel width of the first transistor may be configured to be same as a channel width of the second transistor.

In an embodiment, the weight memory may store a weight in the form of a binary number. Current sources of the first and second current source arrays may correspond to weight bits in the form of the binary number, respectively. A ratio of a length of a time when the first modulation pulse is activated to a length of a time when the second modulation pulse is activated may be determined based on a positional value of bits respectively corresponding to the current sources of the first current source array and a positional value of bits respectively corresponding to the current sources of the second current source array.

In an embodiment, the weight in the form of the binary number may include first to N+Mth bits (where N is a natural number of 1 or more) corresponding to a sequential size. The current sources of the first current source array may correspond to the first to Nth bits, respectively. The current sources of the second current source array may correspond to the N+1st to N+Mth bits, respectively. The length of the time when the second modulation pulse is activated may be 2N times the length of the time when the first modulation pulse is activated.

In an embodiment, the first bit may be a least significant bit for the weight. The N+Mth bit may be a most significant bit for the weight.

In an embodiment, the spike neural network circuit may further include a neuron circuit that generates an output spike signal, when a voltage level of the membrane capacitor is higher than a threshold voltage level.

In an embodiment, the pulse generator may include a clock generator that generates a clock signal in response to the input spike signal, a counter that counts the number of times the clock signal toggles, a first pulse output unit that outputs the first modulation pulse activated before a time point when the counted value is greater than a first reference value from a time point when the input spike signal is received, and a second pulse output unit that outputs the second modulation pulse activated before a time point when the counted value is greater than a second reference value from the time point when the input spike signal is received.

According to an embodiment, a spike neural network circuit may include a pulse generator that receives an input spike signal and generates first and second modulation pulses activated during times of different lengths based on the input spike signal, a first current source and a second current source, a first weight switch connected between the first current source and a first node and a second weight switch connected between the second current source and a second node, a first switch connected between the first node and an output line to operate in response to the first modulation pulse, a second switch connected between the second node and the output line to operate in response to the second modulation pulse, and a membrane capacitor connected with the output line.

In an embodiment, the first modulation pulse may be activated for a shorter time than the second modulation pulse.

In an embodiment, the first modulation pulse and the second modulation pulse may be activated from the same time point.

In an embodiment, a length of a time when the second modulation pulse is activated may be 2N times (wherein N is a natural number of 1 or more) a length of a time when the first modulation pulse is activated.

In an embodiment, the spike neural network circuit may further include a weight memory storing a binary weight. The first weight switch may operate based on a first bit of the binary weight, and the second weight switch may operate based on a second bit of the binary weight.

In an embodiment, the pulse generator may include a first latch circuit including a first set terminal for receiving the input spike signal, a first reset terminal, and a first output terminal, a clock generator connected with the first output terminal to generate a clock signal, a counter that receives the input spike signal and counts the number of times the clock signal toggles, a first comparator that compares a value counted by the counter with a first reference value to generate first and second control signals, a second comparator that compares the counted value with a second reference value to generate third and fourth control signals, a second latch circuit including a second set terminal for receiving the first control signal, a second reset terminal for receiving the second control signal, and a second output terminal for outputting the first modulation pulse, and a third latch circuit including a third set terminal for receiving the third control signal, a fourth reset terminal for receiving the fourth control signal, and a third output terminal for outputting the second modulation pulse. The first reset terminal may be configured to receive the fourth control signal.

In an embodiment, the first control signal and the third control signal may be activated at a time point when the input spike signal fires. The second control signal may be activated at a first time point when the counted value becomes greater than the first reference value. The fourth control signal may be activated at a second time point when the counted value becomes greater than the second reference value.

### BRIEF DESCRIPTION OF THE FIGURES

The above and other objects and features of the present disclosure will become apparent by describing in detail embodiments thereof with reference to the accompanying drawings.

FIG. 1 is a block diagram illustrating a spike neural network circuit according to an embodiment of the present disclosure;

FIG. 2 is a timing diagram for describing an operation of a spike neural network circuit of FIG. 1;

FIG. 3 is a drawing illustrating in detail some components of FIG. 1;

FIG. 4 is a circuit diagram illustrating in detail a synapse circuit of FIG. 3;

FIG. 5 is a drawing illustrating a spike neural network circuit according to an embodiment of the present disclosure;

FIGS. 6A and 6B are drawings for describing an operation of a pulse generator of FIG. 5;

FIG. 7 is a circuit diagram illustrating in detail a synapse circuit of FIG. 5;

FIG. 8 is a block diagram illustrating in detail a pulse generator of FIG. 5;

FIG. 9 is a block diagram illustrating in detail a pulse generator of FIG. 8;

FIG. 10 is a timing diagram illustrating an operation of a pulse generator of FIG. 9;

FIG. 11 is a drawing illustrating a spike neural network circuit according to another embodiment of the present disclosure;

FIG. 12 is a circuit diagram illustrating in detail a synapse circuit of FIG. 11; and

FIG. 13 is a block diagram illustrating in detail a pulse generator of FIG. 11.

### DETAILED DESCRIPTION

Hereinafter, embodiments of the present disclosure will be described clearly and in detail to such an extent that those skilled in the art easily carry out the present disclosure. Specific details such as detailed components and structures are merely provided to assist the overall understanding of the embodiments of the present disclosure. Therefore, changes and modifications of the embodiments described herein may be made by those skilled in the art without departing from the spirit and scope of the present disclosure. In addition, descriptions of the well-known functions and structures are omitted for clarity and simplicity. The following drawings or components in the detailed description may be connected with any other components except for components illustrated in a drawing or described in the detailed description. The terms described in the present disclosure are terms defined in consideration of the functions in the present disclosure and are not limited to a specific function. The definitions of the terms should be determined based on the contents throughout the specification.

Components that are described with reference to the term “unit” or “module” used in the detailed description may be implemented with software, hardware, or a combination thereof. For example, the software may be a machine code, firmware, an embedded code, and application software. For example, the hardware may include an electrical circuit, an electronic circuit, a processor, a computer, integrated circuit cores, a pressure sensor, an inertial sensor, a microelectromechanical system (MEMS), a passive element, or a combination thereof.

The present disclosure relates to a neural network circuit implemented as a semiconductor device. A neural network of the present disclosure may be an artificial intelligence neural network capable of processing a signal and information in a manner similar to a biological neural network. For example, the neural network circuit of the present disclosure may include components corresponding to axon, dendrite, membrane, and synapse, which are components of the biological neural network. Each of the components of the neural network of the present disclosure may perform a function similar to a component of the biological neural network.

Hereinafter, a spike neural network circuit for processing a spike or pulse where a signal is emitted for a short time will be representatively described, but circuits according to an embodiment of the present disclosure are not limited thereto, which may be applied to implement another neural network such as a perceptron-based network or a convolution-based network.

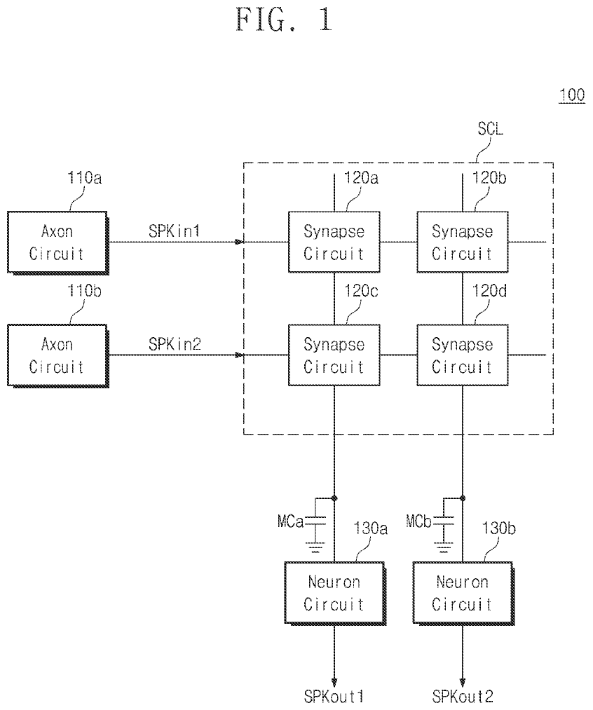

FIG. 1 is a block diagram illustrating a spike neural network circuit according to an embodiment of the present disclosure. Referring to FIG. 1, a spike neural network circuit 100 may include first and second axon circuits 110a and 110b, a synapse circuit layer SCL, and first and second neuron circuits 130a and 130b. The synapse circuit layer SCL may include a plurality of synapse circuits 120a to 120d. Only the two axon circuits 110a and 110b, the two neuron circuits 130a and 130b and the four synapse circuits 120a to 120d are illustrated in the spike neural network circuit 100 of FIG. 1 for a brief description, but the scope of the present disclosure is not limited thereto.

The first axon circuit 110a may output a first input spike signal SPKin1. The first and second synapse circuits 120a and 120b may generate calculation signals in response to the first input spike signal SPKin1.

The second axon circuit 110b may output a second input spike signal SPKin2. The third and fourth synapse circuits 120c and 120d may generate calculation signals in response to the second input spike signal SPKin2.

In an embodiment, the calculation signal may be accumulated in a membrane capacitor through an output line. For example, the calculation signals generated from the first and third synapse circuits 120a and 120c may be accumulated in a first membrane capacitor MCa. The calculation signals generated from the second and fourth synapse circuits 120b and 120d may be accumulated in a second membrane capacitor MCb. In other words, the first and second membrane capacitors MCa and MCb may store the calculation signals in the form of a charge or voltage.

In an embodiment, the first and second membrane capacitors MCa and MCb may perform a function similar to a nerve cell membrane in a biological neural network. For example, the first and second membrane capacitors MCa and MCb may store the received calculation signals to be similar to a nerve cell membrane. In an embodiment, when the calculation signal is received, a voltage level of the membrane capacitor may increase.

Each of the first and second neuron circuits 130a and 130b may output a spike signal based on the calculation signal from the corresponding synapse circuit to be similar to a biological neuron. For example, when a level of the voltage accumulated in the first membrane capacitor MCa is greater than or equal to a threshold voltage, the first neuron circuit 130a may output a first output spike signal SPKout1. In other words, the first neuron circuit 130a may fire based on the voltage level of the first membrane capacitor MCa.

Similarly, when a level of the voltage accumulated in the second membrane capacitor MCb is greater than or equal to the threshold voltage, the second neuron circuit 130b may output a second output spike signal SPKout2. In other words, the second neuron circuit 130b may fire based on the voltage level of the second membrane capacitor MCb.

In an embodiment, each of the first and second neuron circuits 130a and 130b may operate as an axon circuit. In other words, each of the first and second neuron circuits 130a and 130b may provide a spike signal to another synapse layer (not shown).

In an embodiment, unlike network calculation based on perceptron, convolution, or the like, the spike neural network circuit 100 may calculate or deliver a digitized signal in the form of a pulse or spike having a short time width, rather than delivering or calculating the digitalized signal. In this case, the spike signal may be implemented as a voltage. In detail, the spike neural network circuit 100 may be implemented as a digital circuit which operates based on a voltage level divided into being logic high and logic low.

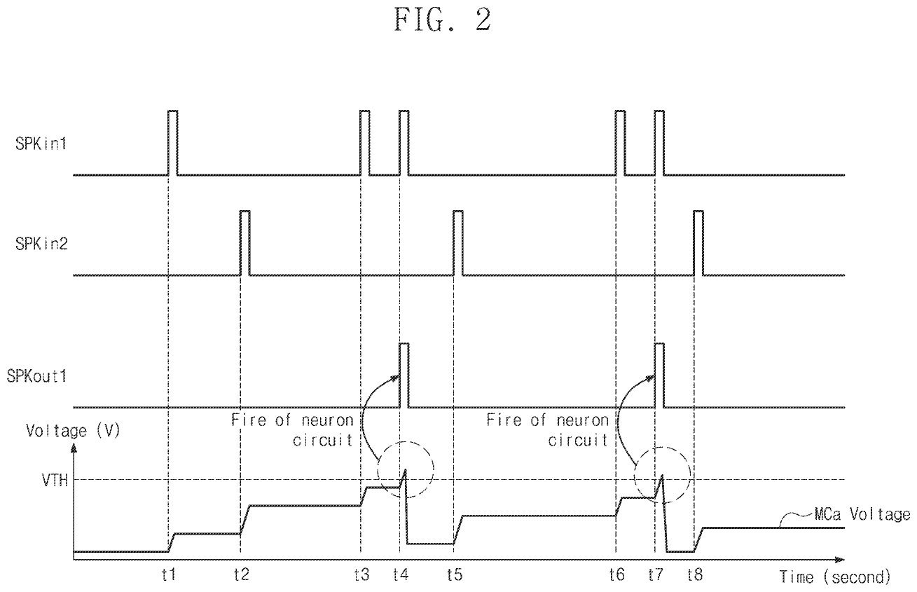

FIG. 2 is a timing diagram for describing an operation of a spike neural network circuit of FIG. 1. In FIG. 2, the horizontal axis represents time, and the vertical axis represents the voltage level. Hereinafter, for a briefer description, a voltage level of a first membrane capacitor MCa, which changes based on first and second input spike signals SPKin1 and SPKin2, will be representatively described. However, the scope of the present disclosure is not limited thereto.

Referring to FIGS. 1 and 2, the first input spike signal SPKin1 may be activated at a first time point t1, a third time point t3, a fourth time point t4, a sixth time point t6, and a seventh time point t7. The second input spike signal SPKin2 may be activated at a second time point t2, a fifth time point t5, and an eighth time point t8.

In an embodiment, weights respectively corresponding to a first axon circuit 110a and a second axon circuit 110b may be the same as or different from each other. For a more detailed description, it is assumed that the weight corresponding to the second axon circuit 110b is greater than the weight corresponding to the first axon circuit 110a. In other words, it is assumed that a weight for the second input spike signal SPKin2 is greater than a weight for the first input spike signal SPKin1. However, the scope of the present disclosure is not limited thereto.

The voltage level of the first membrane capacitor MCa may increase in response to that the first input spike signal SPKin1 or the second input spike signal SPKin2 is activated at the first to fourth time points t1 to t4. Particularly, the voltage level of the first membrane capacitor MCa may become higher than a threshold voltage VTH in response to that the first input spike signal SPKin1 is activated at the fourth time point t4. In this case, the corresponding neuron circuit (i.e., a first neuron circuit 130a) may fire. Thus, a first output spike signal SPKout1 may be activated.

In an embodiment, after the first neuron circuit 130a fires, the voltage level of the first membrane capacitor MCa may decrease to the threshold voltage VTH or less.

The voltage level of the first membrane capacitor MCa may increase in response to that the first input spike signal SPKin1 or the second input spike signal SPKin2 is activated at the fifth to seventh time points t5 to t7. Particularly, the voltage level of the first membrane capacitor MCa may become higher than the threshold voltage VTH in response to that the first input spike signal SPKin1 is activated at the seventh time point t7. In this case, the corresponding neuron circuit (i.e., the first neuron circuit 130a) may fire. Thus, the first output spike signal SPKout1 may be activated.

In other words, the voltage level of the first membrane capacitor MCa may increase in response to that the first input spike signal SPKin1 or the second input spike signal SPKin2 is activated. When the voltage level of the first membrane capacitor MCa increases to the threshold voltage VTH or more, the first neuron circuit 130a may fire. Thus, the first output spike signal SPKout1 may be activated. Thereafter, the voltage level of the first membrane capacitor MCa may decrease.

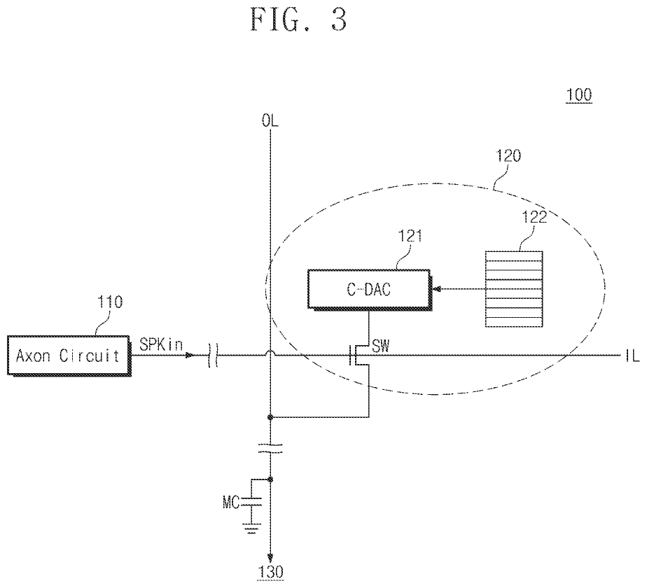

FIG. 3 is a drawing illustrating in detail some components of FIG. 1. In FIG. 3, for a briefer description, a relationship of one synapse circuit 120 with an axon circuit 110 and a neuron circuit 130 will be representatively described. In other words, the synapse circuit 120 may be one of first to fourth synapse circuits 120a to 120d of FIG. 1, and the scope of the present disclosure is not limited thereto.

Referring to FIGS. 1 and 3, the synapse circuit 120 may correspond to the axon circuit 110 and the neuron circuit 130. The synapse circuit 120 may include a current-mode digital-to-analog converter (C-DAC) 121, a weight memory 122, and a switch SW. It is illustrated that the switch SW is included in the synapse circuit 120 for a briefer description, and the scope of the present disclosure is not limited thereto. The switch SW may be located outside the synapse circuit 120.

The axon circuit 110 may provide the synapse circuit 120 with an input spike signal SPKin through an input line IL. The synapse circuit 120 may output a calculation signal through an output line OL in response to the input spike signal SPKin. In this case, a voltage may be accumulated in a membrane capacitor MC connected with the output line OL.

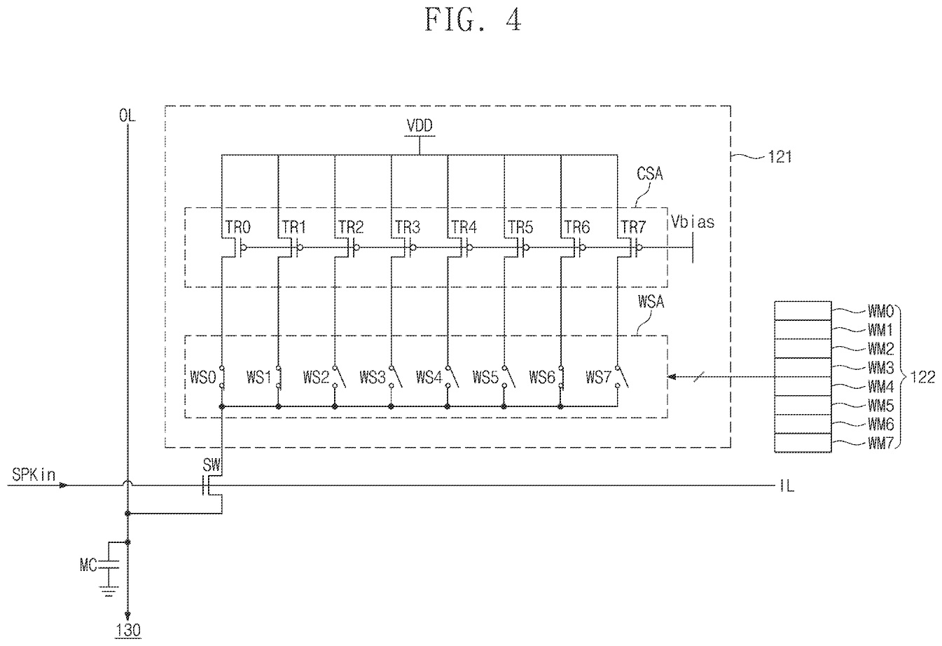

For example, the C-DAC 121 may provide the output line OL with a calculation signal, based on the weight provided from the weight memory 122. For example, the C-DAC 121 may provide the membrane capacitor MC with a current or charge through the output line OL. In this case, a magnitude of a current supplied by the C-DAC 121 through the output line OL may be determined by the weight memory 122. For example, the C-DAC 121 may include a plurality of current sources, each of which has a magnitude of power of 2, which correspond to a binary weight. The configuration of the C-DAC 121 will be described in detail below with reference to FIG. 4.

The weight memory 122 may store a predefined weight and may provide the C-DAC 121 with the stored weight. The weight memory 122 may be implemented as a binary memory. For example, the weight memory 122 may be implemented as a memory which may store 8 bits. However, the scope of the present disclosure is not limited thereto. A size of the binary memory may be variously implemented according to the purpose of a spike neural network circuit 100.

In an embodiment, the weight memory 122 may be implemented as a volatile memory such as a static random access memory (SRAM) or a synchronous dynamic RAM (SDRAM) and may be a non-volatile memory such as a phase-change RAM (PRAM), a magnetic RAM (MRAM), a resistive RAM (RRAM) or a ferroelectric RAM (FRAM) or may be implemented as a combination thereof.

The switch SW may operate in response to the input spike signal SPKin. For example, when the input spike signal SPKin is activated, the switch SW may provide the output line OL with the calculation signal (i.e., current) output from the C-DAC 121.

In an embodiment, the switch SW may be implemented as a transistor. For example, the switch SW may be implemented as a transistor such as a bipolar junction transistor (BJT) or a field effect transistor (FET). In the present disclosure, for a brief description, an embodiment in which the switch SW is implemented as an n-channel metal-oxide-semiconductor (NMOS) transistor will be representatively described. However, the scope of the present disclosure is not limited thereto. For example, the switch SW may be implemented as a p-channel metal-oxide-semiconductor (PMOS) transistor. In this case, an inverter may be further included in the input line IL.

In an embodiment, when the switch SW is implemented as the NMOS transistor, a gate terminal of the switch SW may be connected with the input line IL, a drain terminal of the switch SW may be connected with the C-DAC 121, and a source terminal of the switch SW may be connected with the output line OL.

FIG. 4 is a circuit diagram illustrating in detail a synapse circuit of FIG. 3. Referring to FIGS. 1, 3, and 4, a C-DAC 121 may include a current source array CSA and a weight switch array WSA. A weight memory 122 may include 0th to seventh weight memory cells WM0 to WM7.

The current source array CSA may include a plurality of current sources. Hereinafter, an embodiment in which each of the plurality of current sources is implemented using a PMOS transistor will be representatively described. For example, the current source array CSA may include 0th to seventh transistors TR0 to TR7. In this case, a source terminal of each of the 0th to seventh transistors TR0 to TR7 may be connected to a power voltage VDD, and a gate terminal of each of the 0th to seventh transistors TR0 to TR7 may be connected to a bias voltage Vbias. However, the scope of the present disclosure is not limited thereto. Each of the plurality of current sources may include various embodiments of current sources capable of being implemented by those skilled in the art. In this case, the 0th to seventh transistors TR0 to TR7 may be referred to as 0th to seventh current sources, respectively.

The weight memory 122 may store a weight in the form of a binary number. For example, the 0th to seventh weight memory cells WM0 to WM7 may store each bit of a binary weight. For example, when the binary weight is “01000011₍₂₎”, a k-th weight memory cell WMk (where k is an integer greater than or equal to 0 and less than or equal to 7) may store data of a bit corresponding to 2^{k}. In detail, the 0th weight memory cell WM0 may store data corresponding to a least significant bit (LSB), “1”. The seventh weight memory cell WM7 may store data corresponding to a most significant bit (MSB), “0”. In other words, the 0th to seventh weight memory cells WM0 to WM7 may store “1”, “1”, “0”, “0”, “0”, “0”, “1”, “0”, respectively.

The weight switch array WSA may include 0th to seventh weight switches WS0 to WS7. Each of the 0th to seventh weight switches WS0 to WS7 may be connected between the current source array CSA and the switch SW. For example, the 0th to seventh weight switches WS0 to WS7 may correspond to the 0th to seventh transistors TR0 to TR7, respectively, and each of the 0th to seventh weight switches WS0 to WS7 may be connected between the corresponding transistor and the switch SW. For example, the 0th weight switch WS0 may be connected between the 0th transistor TR0 and the switch SW (in detail, a drain terminal).

The 0th to seventh weight switches WS0 to WS7 may correspond to the 0th to seventh weight memory cells WM0 to WM7, respectively. In other words, each of the 0th to seventh weight switches WS0 to WS7 may be turned on or off based on data stored in the corresponding weight memory cell. For example, in other words, when the 0th to seventh weight switches WS0 to WS7 store “1”, “1”, “0”, “0”, “0”, “0”, “1”, and “0”, respectively, the 0th, first, and sixth weight switches WS0, WS1, and WS6 may be turned on, and the second, third, fourth, fifth, and seventh weight switches WS2, WS3, WS4, WS5, and WS7 may be turned off.

In an embodiment, each of the 0th to seventh current sources (i.e., the 0th to seventh transistors TR0 to TR7) may generate a current of a magnitude corresponding to a binary weight. For example, the magnitude of a current generated by the first current source (or the first transistor TR1) may be two times the magnitude of a current generated by the 0th current source (or the 0th transistor TR0) and the magnitude of a current generated by the second current source (or the second transistor TR2) may be four times the magnitude of a current generated by the 0th current source (or the 0th transistor TR0). Similarly, the magnitude of a current generated by the kth current source (or the kth transistor TRIO may be 2^{k} times the magnitude of a current generated by the 0th current source (or the 0th transistor TR0). In this case, a current of a magnitude proportional to the weight stored in the weight memory WM may be supplied to the output line OL through the switch SW. Thus, a voltage may be accumulated in the membrane capacitor MC as much as it corresponds to a weight of a synapse circuit 120.

In an embodiment, when the weight memory WM stores more bits (i.e., when the synapse circuit 120 with high performance is implemented), a current source which generates a current of a higher magnitude may be included in the synapse circuit 120. For example, when the weight memory WM stores 8 bits, a current source (e.g., the seventh transistor TR7) which generates a current having a magnitude of 256 times compared to a current source (e.g., the 0th transistor TR0) which generates a current of the smallest magnitude may be included in the synapse circuit 120. In other words, when the synapse circuit 120 operates based on a 4-bit weight memory, the magnitude of a current of a current source corresponding to the most significant bit (MSB) may be 16 times the magnitude of a current of a current source corresponding to the least significant bit (LSB). However, when the synapse circuit 120 operates based on an 8-bit weight memory, the magnitude of a current of a current source corresponding to the MSB may be 256 times the magnitude of a current of a current source corresponding to the LSB. When the synapse circuit 120 operates based on a 12-bit weight memory, the magnitude of a current of a current source corresponding to the MSB may be 4096 times the magnitude of a current of a current source corresponding to the LSB.

In an embodiment, the 0th to seventh transistors TR0 to TR7 may have different channel widths. For example, a transistor (e.g., the seventh transistor TR7) which generates relatively high current may be implemented to have relatively wide channel width. In detail, the seventh transistor TR7 may have a channel width about 256 times larger than that of the 0th transistor TR0. Therefore, as the weight memory WM stores more bits, a channel width of a transistor for implementing a current source which generates a high current may increase exponentially. Thus, the area of the synapse circuit 120 may increase.

Furthermore, precision of a spike neural network circuit 100 may be determined based on precision of a size of the current source. Thus, to reduce an error on a semiconductor process, a channel width and a channel length of a transistor constituting the current source should be designed to be relatively large. Thus, the area of the synapse circuit 120 may increase.

Hereinafter, an embodiment in which a synapse circuit having the same precision is implemented by means of a transistor having a smaller size (i.e., a smaller channel width).

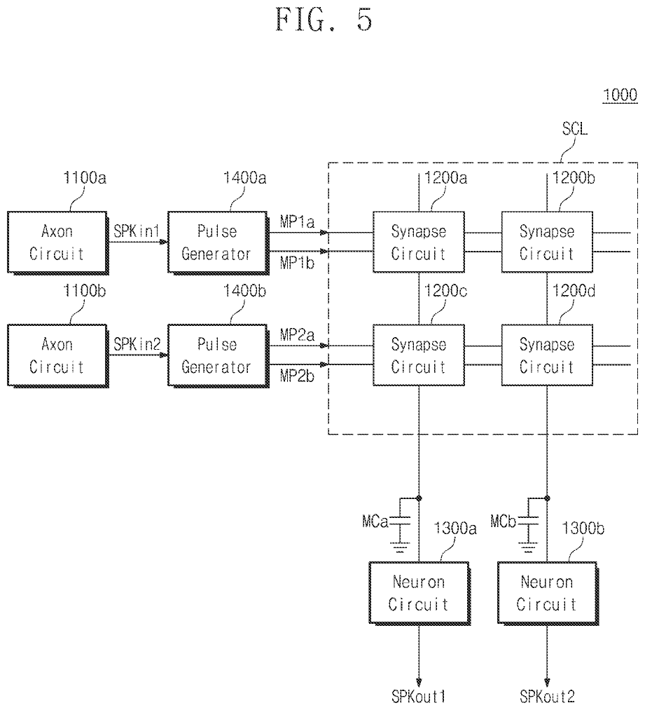

FIG. 5 is a block diagram illustrating a spike neural network circuit according to an embodiment of the present disclosure. Referring to FIG. 5, a spike neural network circuit 1000 may include first and second axon circuits 1100a and 1100b, a synapse circuit layer SCL, first and second neuron circuits 1300a and 1300b, and first and second pulse generators 1400a and 1400b. The synapse circuit layer SCL may include a plurality of synapse circuits 1200a to 1200d. Because functions of the first and second axon circuits 1100a and 1100b, the first and second neuron circuits 1300a and 1300b, and the first to fourth synapse circuits 1200a to 1200d are similar to those described with reference to FIG. 1, a detailed description thereof will be omitted. In other words, hereinafter, a difference with the components of FIG. 1 will be mainly described.

The first and second pulse generators 1400a and 1400b may receive first and second input spike signals SPKin1 and SPKin2, respectively, to generate a plurality of modulation pulses. For example, the first pulse generator 1400a may generate modulation pulses MP1a and MP1b, based on a first input spike signal SPKin1. The second pulse generator 1400b may generate modulation pulses MP2a and MP2b, based on a second input spike signal SPKin2.

In an embodiment, each of the plurality of synapse circuits 1200a to 1200d may be connected with the first and second pulse generators 1400a and 1400b through a plurality of input lines.

The first and second synapse circuits 1200a and 1200b may generate calculation signals in response to the modulation pulses MP1a and MP1b. The third and fourth synapse circuits 1200c and 1200d may generate calculation signals in response to the modulation pulses MP2a and MP2b.

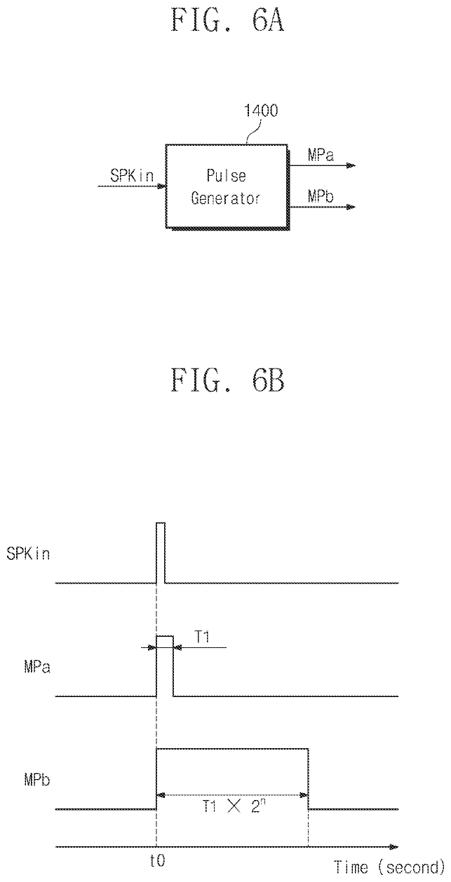

FIGS. 6A and 6B are drawings for describing an operation of a pulse generator of FIG. 5. Hereinafter, for a briefer description, an operation of one pulse generator 1400 will be representatively described. In other words, the pulse generator 1400 described with reference to FIGS. 6A and 6B may be one of first and second pulse generators 1400a and 1400b of FIG. 5, but the scope of the present disclosure is not limited thereto.

Referring to FIG. 5 and FIG. 6A, the pulse generator 1400 may receive an input spike signal SPKin and may output a first modulation pulse MPa and a second modulation pulse MPb.

In an embodiment, the first modulation pulse MPa may be activated during a time length different from that of the second modulation pulse MPb. For example, the first modulation pulse MPa may be activated during a shorter time length than that of the second modulation pulse MPb.

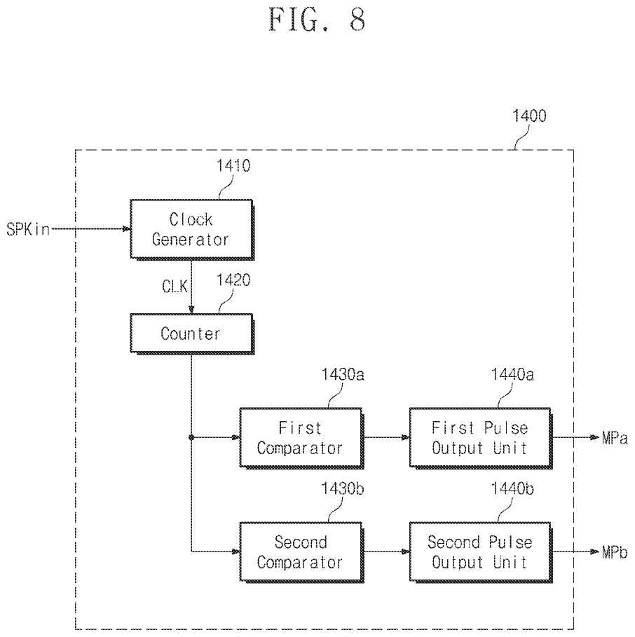

A detailed configuration of the pulse generator 1400 will be described below with reference to FIGS. 8 to 10.

Referring to FIG. 6B, a relationship among an input spike signal SPKin, a first modulation pulse MPa, and a second modulation pulse MPb is illustrated.

First of all, the input spike signal SPKin may be activated at a 0th time point to. For example, a voltage level of the input spike signal SPKin may transition to a logic high level at the 0th time point t0. Simultaneously, the first modulation pulse MPa and the second modulation pulse MPb may be activated. In other words, the first modulation pulse MPa and the second modulation pulse MPb may be activated at the same time point (e.g., the 0th time point t0) as the input spike signal SPKin.

The first modulation pulse MPa and the second modulation pulse MPb may be activated during different time lengths. For example, the first modulation pulse MPa may be activated during a first time T1 from the 0th time point t0. On the other hand, the second modulation pulse MPb may be activated during a time (T1×2^{N}) (where N is a natural number of 1 or more) 2^{N} times longer than the first time T1.

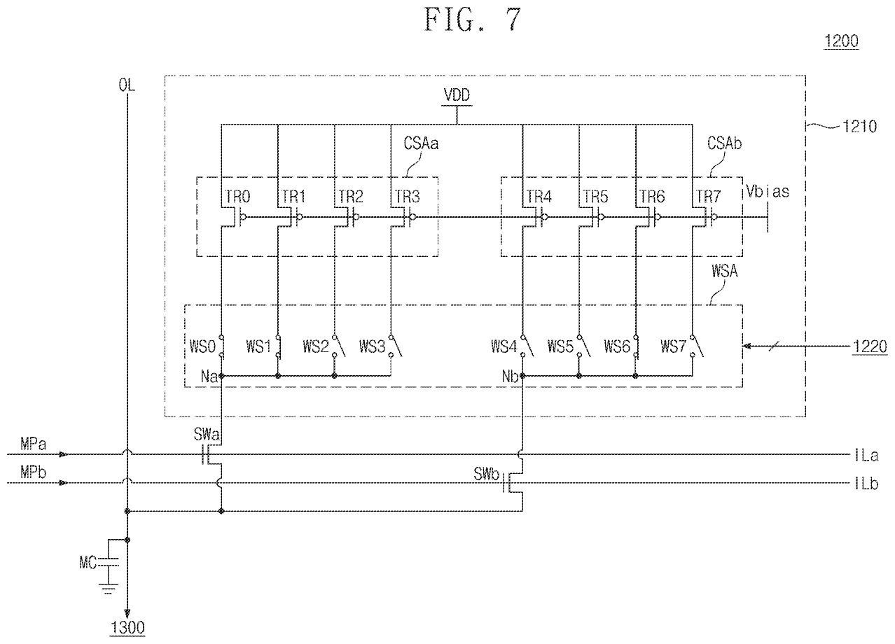

In an embodiment, N may be determined based on a manner which implements a synapse circuit 1200. The manner which determines N depending on the implementation of the synapse circuit 1200 will be described in detail below with reference to FIG. 7.

FIG. 7 is a circuit diagram illustrating in detail a synapse circuit of FIG. 5. Referring to FIG. 7, a synapse circuit 1200 may include a C-DAC 1210, a weight memory 1220, and first and second switches SWa and SWb. The C-DAC 1210 may include first and second current source arrays CSAa and CSAb and a weight switch array WSA.

Because the configuration and function of the C-DAC 1210, the weight memory 1220, and the weight switch array WSA are similar to those described above with reference to FIG. 4, a detailed description thereof will be omitted.

Each of 0th to seventh transistors TR0 to TR7 may be divided into the first current source array CSAa and the second current source array CSAb. For example, the first current source array CSAa may include the 0th to third transistors TR0 to TR3. The second current source array CSAb may include the fourth to seventh transistors TR4 to TR7.

Each of 0th to third weight switches WS0 to WS3 may be connected between the first current source array CSAa and a first node Na. For example, the 0th weight switch WS0 may be connected between the 0th transistor TR0 and the first node Na. Similarly, the first weight switch WS1 may be connected between the first transistor TR1 and the first node Na.

Each of fourth to seventh weight switches WS4 to WS7 may be connected between the second current source array CSAb and a second node Nb. For example, the fourth weight switch WS4 may be connected between the fourth transistor TR4 and the second node Nb. Similarly, the fifth weight switch WS5 may be connected between the fifth transistor TR5 and the second node Nb.

Because the operation of each of the 0th to seventh weight switches WS0 to WS7 is similar to that described above with reference to FIG. 4, a detailed description thereof will be omitted.

The first switch SWa may be connected between the first node Na and an output line OL. The first switch SWa may operate in response to a first modulation pulse MPa received through a first input line ILa. For example, the first switch SWa may be implemented as an NMOS transistor, a gate terminal of which is connected with the first input line ILa.

The second switch SWb may be connected between the second node Nb and the output line OL. The second switch SWb may operate in response to a second modulation pulse MPb received through a second input line ILb. For example, the second switch SWb may be implemented as an NMOS transistor, a gate terminal of which is connected with the second input line ILb.

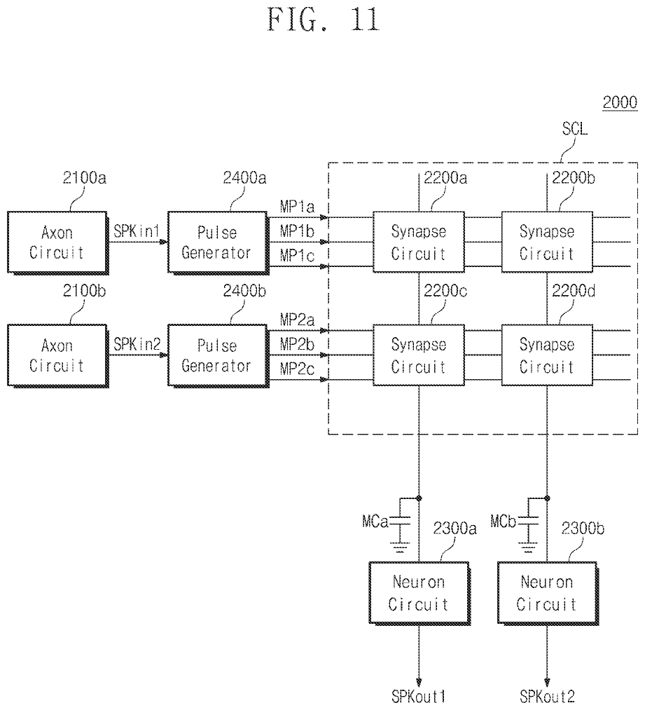

In other words, according to an embodiment of the present disclosure, the one synapse circuit 1200 may include two or more switches SWa and SWb which operate based on the single input spike signal SPKin. Hereinafter, an embodiment in which two switches are included in the synapse circuit 1200 will be representatively described for a briefer description, but the scope of the present disclosure is not limited thereto. The synapse circuit 1200 may include three or more switches. For example, an embodiment in which the synapse circuit includes three or more switches will be described in detail below with reference to FIGS. 11 to 13.

In an embodiment, as described above with reference to FIG. 6B, a second modulation pulse MPb may be activated for a longer time than a first modulation pulse MPa. In this case, a time when the second switch SWb may be longer in length than a time when the first switch SWa is turned on. In other words, although the first current source array CSAa and the second current source array CSAb generate the current of the same magnitude, a voltage accumulated in a membrane capacitor MC as the second switch SWb is turned on may be greater in magnitude than a voltage accumulated in the membrane capacitor MC as the first switch SWa is turned on. Thus, as a ratio of a time when the first modulation pulse MPa is activated to a time when the second modulation pulse MPb is activated is adjusted, although a size (specifically a channel width or the like) of the transistor of the second current source array CSAb is not adjusted, the amount of charge accumulated in the membrane capacitor MC may be proportional to a magnitude of a weight.

For example, unlike those described above with reference to FIG. 4, the fourth to seventh transistors TR4 to TR7 may be implemented with the same channel width as the 0th to third transistors TR0 to TR3. Thus, current sources (e.g., the fourth to seventh transistors TR4 to TR7) corresponding to a high place value of the binary weight may decrease in size. Thus, the synapse circuit 1200 may decrease in size.

In an embodiment, to adjust the amount of charge accumulated in the membrane capacitor MC to be proportional to the size of the weight, the ratio of the time when the first modulation pulse MPa is activated to the time when the second modulation pulse MPb is activated may be adjusted. For example, when the first current source array CSAa and the second current source array CSAb are implemented as transistors which are the same as each other, the second modulation pulse MPb may be determined to be activated for 16 times longer than the first modulation pulse MPa. In other words, N of FIG. 6B may be determined as 4.

For another example, when a current source (referred to as a “first current source”) which generates a current of the smallest magnitude among current sources of the first current source array CSAa generates a current of the same magnitude as a current source (referred to as a “second current source”) which generates a current of the smallest magnitude among current sources of the second current source array CSAb, “n” may be determined based on a place value of bits of a weight corresponding to the first current source and a place value of bits of a weight corresponding to the second current source. For example, in the embodiment of FIG. 7, the first current source may be the 0th transistor TR0, and a place value of bits of a weight corresponding to the 0th transistor TR0 may be 1 (=2⁰). The second current source may be the fourth transistor TR4, and a place value of bits of a weight corresponding to the fourth transistor TR4 may be 16 (=2⁴). In this case, the second modulation pulse MPb may be determined to be activated for 16 times longer than the first modulation pulse MPa.

In other words, according to an embodiment of the present disclosure, a charge of a different magnitude may be accumulated in the membrane capacitor MC for each weight bit, based on multiplication of a magnitude of current of each of a plurality of current sources and a time when the modulation signal is activated. Thus, the scope of the present disclosure is not limited to a manner which divides a bit number of a weight memory, a magnitude of current of each of current sources, and a current source array. For example, the scope of the present disclosure may include various embodiments in which the multiplication of the magnitude of current of each of the plurality of current sources and the time when the modulation signal is activated is determined according to a power of 2.

FIG. 8 is a block diagram illustrating in detail a pulse generator of FIG. 5. Referring to FIG. 8, a pulse generator 1400 may include a clock generator 1410, a counter 1420, first and second comparators 1430a and 1430b, and first and second pulse output units 1440a and 1440b.

The clock generator 1410 may receive an input spike signal SPKin to generate a clock signal. The counter 1420 may count the number of times the clock signal toggles. For example, when the clock signal toggles, a count value of the counter 1420 may increase by “1”.

The first comparator 1430a may compare the count value with a first reference value. The first reference value may be determined according to a length of a time when a first modulation pulse MPa is activated. The first pulse output unit 1440a may output the first modulation pulse MPa until it is determined by the first comparator 1430a that the count value is greater than the first reference value.

The second comparator 1430b may compare the count value with a second reference value. The second reference value may be determined according to a length of a time when a second modulation pulse MPb is activated. The second pulse output unit 1440b may output the second modulation pulse MPb until it is determined by the second comparator 1430b that the count value is greater than the second reference value.

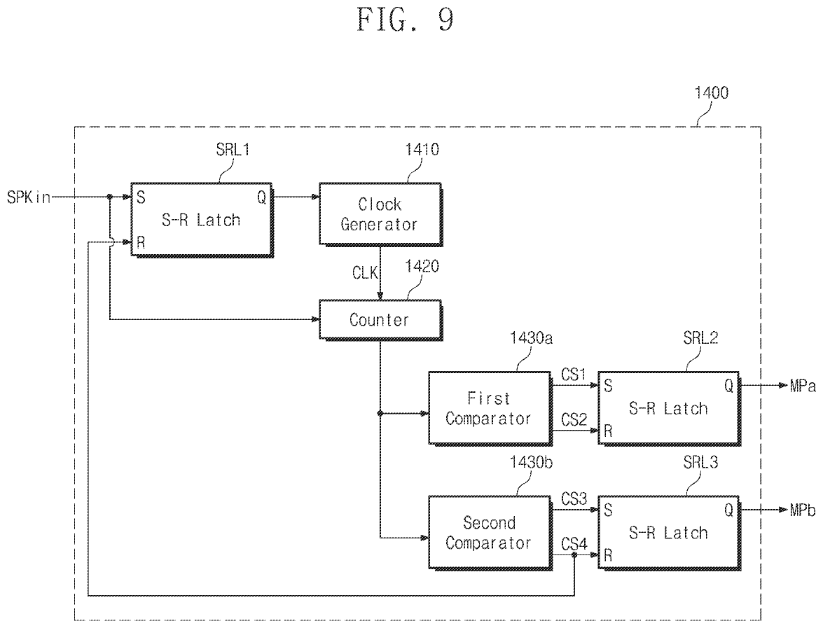

FIG. 9 is a block diagram illustrating in detail a pulse generator of FIG. 8. Referring to FIGS. 8 and 9, a pulse generator 1400 may include first to third latch circuits SRL1 to SRL3, a clock generator 1410, a counter 1420, and first and second comparators 1430a and 1430b.

A set terminal S of the first latch circuit SRL1 may receive an input spike signal SPKin. An output terminal Q of the first latch circuit SRL1 may be connected with the clock generator 1410. The clock generator 1410 may generate a clock signal CLK which toggles from a time point when a voltage level of the output terminal Q transitions to a logic high level.

The counter 1420 may receive the clock signal CLK. The counter 1420 may count the number of times the clock signal CLK toggles. For example, the counter 1420 may increase a count value by “1” whenever the clock signal CLK transitions from a logic low level to a logic high level. However, the scope of the present disclosure is not limited thereto. In an embodiment, the count value may be initialized at a time point when the input spike signal SPKin transitions to the logic high level.

The first comparator 1430a may compare the count value of the counter 1420 with a first reference value. The first reference value may be determined according to a length of a time when a first modulation pulse MPa is activated. The first comparator 1430a may activate a first control signal CS1 at a time point when the count value increases from “0” to “1”. The first comparator 1430a may activate a second control signal CS2 at a time point when the count value becomes greater than the first reference value.

The second comparator 1430b may compare the count value of the counter 1420 with a second reference value. The second reference value may be determined according to a length of a time when a second modulation pulse MPb is activated. The second comparator 1430b may activate a third control signal CS3 at a time point when the count value increases from “0” to “1”. In other words, the first control signal CS1 and the third signal CS3 may be activated at the same time. The second comparator 1430b may activate a fourth control signal CS4 at a time point when the count value becomes greater than the second reference value. The fourth control signal CS4 may be provided to a reset terminal R of the first latch circuit SRL1.

The second latch circuit SRL2 may correspond to a first pulse output unit 1440a. For example, a set terminal S of the second latch circuit SRL2 may receive the first control signal CS1. A reset terminal R of the second latch circuit SRL2 may receive the second control signal CS2. In this case, an output terminal Q of the second latch circuit SRL2 may output the first modulation pulse MPa.

The third latch circuit SRL3 may correspond to a second pulse output unit 1440b. For example, a set terminal S of the third latch circuit SRL3 may receive the third control signal CS3. A reset terminal R of the third latch circuit SRL3 may receive the fourth control signal CS4. In this case, an output terminal Q of the third latch circuit SRL3 may output the second modulation pulse MPb.

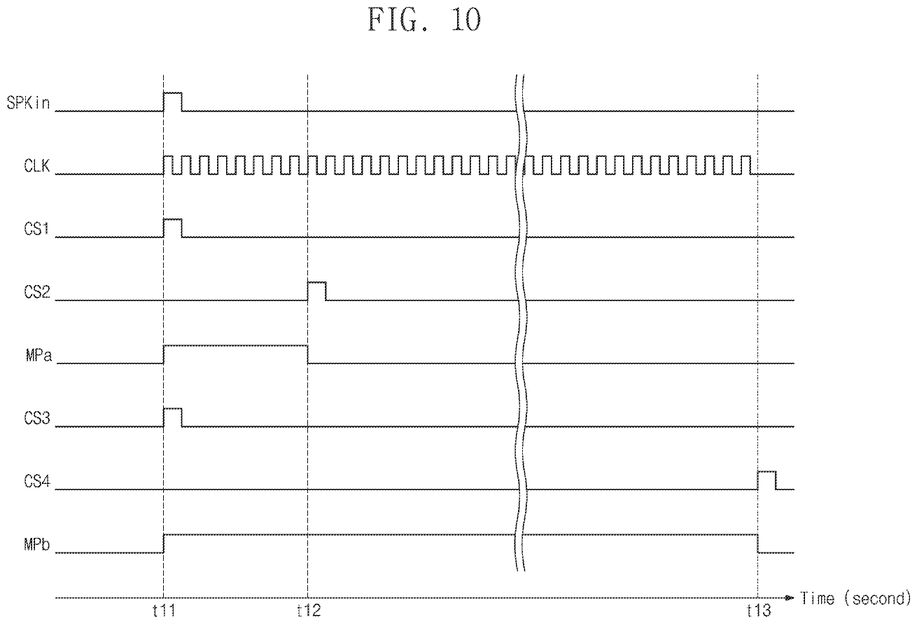

FIG. 10 is a timing diagram illustrating an operation of a pulse generator of FIG. 9. Referring to FIGS. 9 and 10, an input spike signal SPKin may transition to a logic high level at an eleventh time point t11. In other words, the input spike signal SPKin may fire at the eleventh time point t11. Thus, a clock generator 1410 may generate a clock signal CLK which toggles from the eleventh time point t11.

At the eleventh time point t11 when the clock signal CLK transitions to the logic high level, a first comparator 1430a and a second comparator 1430b may activate a first control signal CS1 and a third control signal CS3, respectively.

The first comparator 1430a may activate the third control time point CS3 at a twelfth time point t12 when the count value becomes greater than a first reference value. In this case, a time interval between the eleventh time point t11 and the twelfth time point t12 may correspond to a time interval when a first modulation pulse MPa is activated.

The second comparator 1430b may activate a fourth control time point CS4 at a 13th time point t13 when the count value becomes greater than a second reference value. In this case, a time interval among the eleventh to 13th time points t11 to t13 may correspond to a time interval when a second modulation pulse MPb is activated.

In other words, a ratio of a length of a time when the first modulation pulse MPa is activated to a length of a time when the second modulation pulse MPb is activated may be adjusted according to settings of the first reference value and the second reference value.

In an embodiment, the length of the time when the first modulation pulse MPa is activated may be shorter than a length of a time when the input spike signal SPKin is activated. However, the scope of the present disclosure is not limited thereto. The length of the time when the first modulation pulse MPa is activated may be the same as the length of the time when the input spike signal SPKin is activated.

FIG. 11 is a block diagram illustrating a spike neural network circuit according to another embodiment of the present disclosure. Referring to FIG. 11, a spike neural network circuit 2000 may include first and second axon circuits 2100a and 2100b, a synapse circuit layer SCL, first and second neuron circuits 2300a and 2300b, and first and second pulse generators 2400a and 2400b. The synapse circuit layer SCL may include a plurality of synapse circuits 2200a to 2200d. Because functions of the first and second axon circuits 2100a and 2100b, the first and second neuron circuits 2300a and 2300b, and the first to fourth synapse circuits 2200a to 2200d are similar to those described with reference to FIG. 1, a detailed description thereof will be omitted. In other words, hereinafter, a difference with FIG. 5 will be mainly described.

The first and second pulse generators 2400a and 2400b may receive first and second input spike signals SPKin1 and SPKin2, respectively, to generate a plurality of modulation pulses. For example, the first pulse generator 2400a may generate modulation pulses MP1a, MP1b, and MP1c, based on the first input spike signal SPKin1. The second pulse generator 1400b may generate modulation pulses MP2a, MP2b, and MP2c, based on the second input spike signal SPKin2. In other words, each of the first and second pulse generators 2400a and 2400b may generate three types of modulation pulses. In this case, the modulation pulses generated by the first and second pulse generators 2400a and 2400b may be activated during times of different lengths.

The first and second synapse circuits 2200a and 2200b may be connected with the first pulse generator 2400a through three input lines. The first and second synapse circuits 2200a and 2200b may receive the modulation pulses MP1a, MP1b, and MP1c from the first pulse generator 2400a. The first and second synapse circuits 2200a and 2200b may generate calculation signals based on the modulation pulses MP1a, MP1b, and MP1c.

The third and fourth synapse circuits 2200c and 2200d may be connected with the second pulse generator 2400b through three input lines. The third and fourth synapse circuits 2200c and 2200d may receive the modulation pulses MP2a, MP2b, and MP2c from the second pulse generator 2400b. The third and fourth synapse circuits 2200c and 2200d may generate calculation signals based on the modulation pulses MP2a, MP2b, and MP2c.

In an embodiment, by generating the calculation signals based on the plurality of modulation pulses activated during times of various lengths, a synapse circuit 2200 may be implemented in a more compact size.

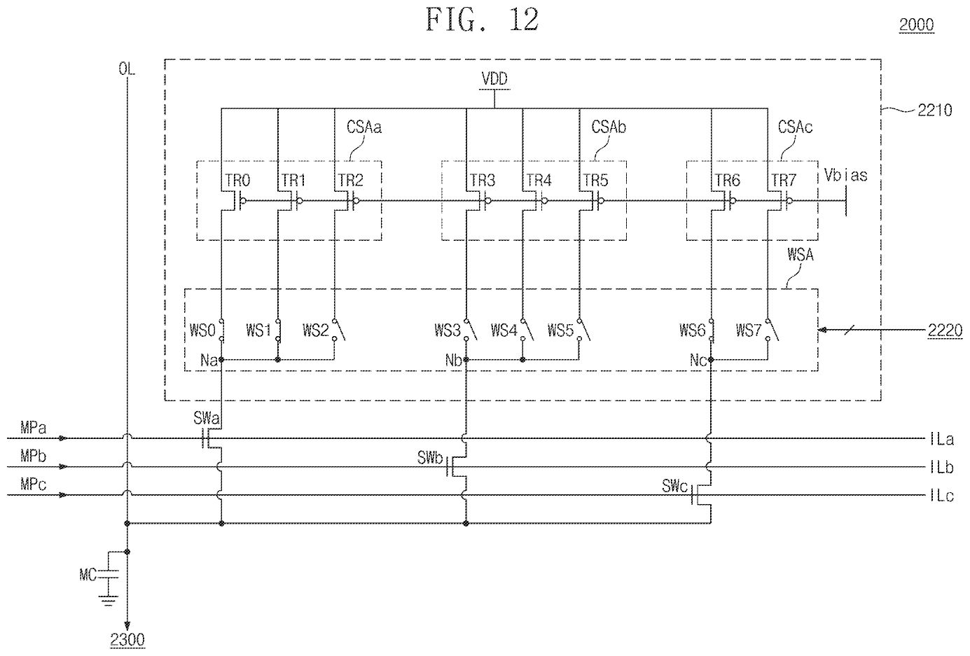

FIG. 12 is a circuit diagram illustrating in detail a synapse circuit of FIG. 11. Referring to FIGS. 11 and 12, a synapse circuit 2200 may include a C-DAC 2210, a weight memory 2220, and first to third switches SWa to SWc. The C-DAC 2210 may include first to third current source arrays CSAa to CSAc and a weight switch array WSA. Because the configuration and function of the C-DAC 2210, the weight memory 2220, and the weight switch array WSA are similar to those described above with reference to FIG. 7, a detailed description thereof will be omitted.

Each of 0th to seventh transistors TR0 to TR7 may be divided into the first to third current source arrays CSAa to CSAc. For example, the first current source array CSAa may include 0th to second transistors TR0 to TR2. The second current source array CSAb may include third to fifth transistors TR3 to TR5. The third current source array CSAc may include sixth and seventh transistors TR6 and TR7. However, the scope of the present disclosure is not limited thereto. Each of 0th to seventh transistors TR0 to TR7 may be divided into the first to third current source arrays CSAa to CSAc in various manners.

Each of 0th to second weight switches WS0 to WS2 may be connected between the first current source array CSAa and a first node Na. Each of third to fifth weight switches WS3 to WS5 may be connected between the second current source array CSAb and a second node Nb. Each of sixth and seventh weight switches WS6 and WS7 may be connected between the third current source array CSAc and a third node Nc. Because the connection relationship and the function of each of the 0th to seventh weight switches WS0 to WS7 are similar to those described above with reference to FIG. 7, a detailed description thereof will be omitted.

The first switch SWa may be connected between the first node Na and an output line OL. The second switch SWb may be connected between the second node Nb and the output line OL. The third switch SWc may be connected between the third node Nc and the output line OL. The first switch SWa may operate in response to a first modulation pulse MPa received through a first input line ILa. The second switch SWb may operate in response to a second modulation pulse MPb received through a second input line ILb. The third switch SWc may operate in response to a third modulation pulse MPc received through a third input line ILc.

In an embodiment, the second modulation pulse MPb may be activated for a longer time than the first modulation pulse MPa, and the third modulation pulse MPc may be activated for a longer time than the second modulation pulse MPb. For example, the second modulation pulse MPb may be activated for 8 times longer than the first modulation pulse MPa, and the third modulation pulse MPc may be activated for 32 times longer than the first modulation pulse MPa. However, the scope of the present disclosure is not limited thereto. A ratio of times when the modulation pulses are activated may be determined according to a manner which divides a corresponding current source array. In this case, current sources of the second and third current source arrays CSAb and CSAc may be implemented as transistors, each of which has a smaller channel width. Thus, a synapse circuit 2200 may be more miniaturized in size.

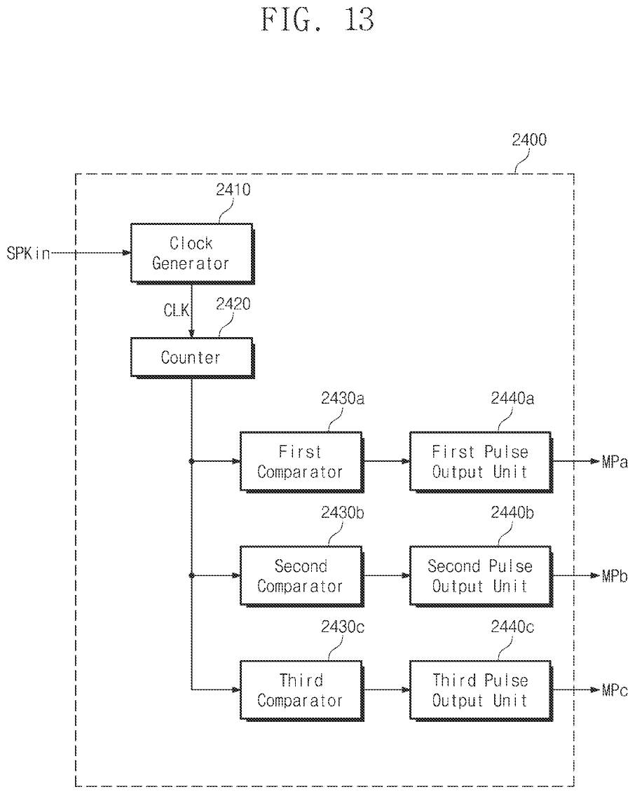

FIG. 13 is a block diagram illustrating in detail a pulse generator of FIG. 11. Referring to FIG. 13, a pulse generator 2400 may include a clock generator 2410, a counter 2420, first to third comparators 2430a to 2430c, and first to third pulse output units 2440a to 2440c. Because the clock generator 2410, the counter 2420, the first and second comparators 2430a and 2430b, and the first and second pulse output units 2440a and 2440b are able to perform operations similar to those described above with reference to FIG. 8, a detailed description thereof will be omitted.

The third comparator 2430c may compare a count value with a third reference value. The third reference value may be determined according to a length of a time when a third modulation pulse MPc is activated. The third pulse output unit 2440c may output the third modulation pulse MPc up to a time point when it is determined by the third comparator 2430c that the count value is greater than the third reference value. In other words, according to an embodiment of the present disclosure, the pulse generator 2400 may generate a plurality of modulation pulses activated during various time lengths in response to an input spike signal SPKin. Thus, as a different charge accumulation time is applied for each current source array in a synapse circuit 2200, the calculation of high precision may be implemented although a transistor of a smaller size is used.

According to the present disclosure, a spike neural network circuit in which an area of a synapse circuit is reduced may be provided.

The above-mentioned contents are detailed embodiments for executing the present disclosure. The present disclosure may include embodiments capable of being simply changed in design or being easily changed, as well as the above-mentioned embodiments. Furthermore, the present disclosure may also include technologies capable of being easily modified and executed using embodiments. While the present disclosure has been described with reference to exemplary embodiments thereof, it will be apparent to those of ordinary skill in the art that various changes and modifications may be made thereto without departing from the spirit and scope of the present disclosure as set forth in the following claims.

What is claimed is:

1. A spike neural network circuit, comprising:
a pulse generator configured to receive an input spike signal, and to generate a first modulation pulse and a second modulation pulse based on the input spike signal;
first and second current source arrays controlled based on a weight memory;
a membrane capacitor;
a first switch configured to deliver a first calculation signal generated from the first current source array to the membrane capacitor, in response to the first modulation pulse; and
a second switch configured to deliver a second calculation signal generated from the second current source array to the membrane capacitor, in response to the second modulation pulse.

2. The spike neural network circuit of claim 1, wherein the first modulation pulse is activated for a shorter time than the second modulation pulse.

3. The spike neural network circuit of claim 2, wherein the first modulation pulse and the second modulation pulse are activated from the same time point.

4. The spike neural network circuit of claim 2, wherein the membrane capacitor is configured to:
accumulate the first calculation signal during a time interval when the first modulation pulse is activated; and
accumulate the second calculation signal during a time interval when the second modulation pulse is activated.

5. The spike neural network circuit of claim 1, wherein a first current source for generating a current of a smallest magnitude among current sources of the first current source array generates a current of the same magnitude as a second current source for generating a current of a smallest magnitude among current sources of the second current source array.

6. The spike neural network circuit of claim 5, wherein the first current source and the second current source include a first transistor and a second transistor, respectively, and
wherein a channel width of the first transistor is configured to be same as a channel width of the second transistor.

7. The spike neural network circuit of claim 1, wherein the weight memory is configured to store a weight in form of a binary number,
wherein current sources of the first and second current source arrays correspond to weight bits in the form of the binary number, respectively, and
wherein a time length ratio of the first modulation pulse being activated and the second modulation pulse being activated is determined based on a positional value of bits respectively corresponding to the current sources of the first current source array and a positional value of bits respectively corresponding to the current sources of the second current source array.

8. The spike neural network circuit of claim 7, wherein the weight in the form of the binary number includes first to N+Mth bits (where N is a natural number of 1 or more) corresponding to a sequential size,
wherein the current sources of the first current source array correspond to the first to Nth bits, respectively,
wherein the current sources of the second current source array correspond to the N+1st to N+Mth bits, respectively, and
wherein time length of the second modulation pulse being activated is 2^{N} times of time length of the first modulation pulse being activated.

9. The spike neural network circuit of claim 8, wherein the first bit is a least significant bit for the weight, and
wherein the N+Mth bit is a most significant bit for the weight.

10. The spike neural network circuit of claim 1, further comprising:
a neuron circuit configured to generate an output spike signal, when a voltage level of the membrane capacitor is higher than a threshold voltage level.

11. The spike neural network circuit of claim 1, wherein the pulse generator includes:
a clock generator configured to generate a clock signal in response to the input spike signal;
a counter configured to count the number of times the clock signal toggles;
a first pulse output unit configured to output the first modulation pulse activated before a time point when the counted value is greater than a first reference value from a time point when the input spike signal is received; and
a second pulse output unit configured to output the second modulation pulse activated before a time point when the counted value is greater than a second reference value from the time point when the input spike signal is received.

12. A spike neural network circuit, comprising:
a pulse generator configured to receive an input spike signal and generate first and second modulation pulses activated during times of different lengths based on the input spike signal;
a first current source and a second current source;
a first weight switch connected between the first current source and a first node and a second weight switch connected between the second current source and a second node;
a first switch connected between the first node and an output line and configured to operate in response to the first modulation pulse;
a second switch connected between the second node and the output line and configured to operate in response to the second modulation pulse; and
a membrane capacitor connected with the output line.

13. The spike neural network circuit of claim 12, wherein the first modulation pulse is activated for a shorter time than the second modulation pulse.

14. The spike neural network circuit of claim 13, wherein the first modulation pulse and the second modulation pulse are activated from the same time point.

15. The spike neural network circuit of claim 13, wherein a length of a time when the second modulation pulse is activated is 2N times (wherein N is a natural number of 1 or more) a length of a time when the first modulation pulse is activated.

16. The spike neural network circuit of claim 12, further comprising:
a weight memory storing a binary weight,
wherein the first weight switch operates based on a first bit of the binary weight, and the second weight switch operates based on a second bit of the binary weight.

17. The spike neural network circuit of claim 12, wherein the pulse generator includes:
a first latch circuit including a first set terminal for receiving the input spike signal, a first reset terminal, and a first output terminal;
a clock generator connected with the first output terminal and configured to generate a clock signal;
a counter configured to receive the input spike signal and count the number of times the clock signal toggles;
a first comparator configured to compare a value counted by the counter with a first reference value to generate first and second control signals;
a second comparator configured to compare the counted value with a second reference value to generate third and fourth control signals;
a second latch circuit including a second set terminal for receiving the first control signal, a second reset terminal for receiving the second control signal, and a second output terminal for outputting the first modulation pulse; and
a third latch circuit including a third set terminal for receiving the third control signal, a fourth reset terminal for receiving the fourth control signal, and a third output terminal for outputting the second modulation pulse,
wherein the first reset terminal is configured to receive the fourth control signal.

18. The spike neural network circuit of claim 17, wherein the first control signal and the third control signal are activated at a time point when the input spike signal fires,
wherein the second control signal is activated at a first time point when the counted value becomes greater than the first reference value, and
wherein the fourth control signal is activated at a second time point when the counted value becomes greater than the second reference value.
